(19) United States
(12) Patent Application Publication
(10) Pub. No.: US 2026/0367844 A1
(43) Pub. Date: Nov. 19, 2026

(54) PRINT SETTING METHOD, INFORMATION PROCESSING APPARATUS, AND NON-TRANSITORY TANGIBLE RECORDING MEDIUM

(71) Applicant: SHARP KABUSHIKI KAISHA, Osaka (JP)

(72) Inventors: MASASHI ICHIKAWA, Osaka (JP); KENICHIROH IMAYOSHI, Osaka (JP); Yuya TSUJIBAYASHI, Osaka (JP); Kazuhiro YOSHIMOTO, Osaka (JP); YOSHITAKA OGATA, Osaka (JP)

(21) Appl. No.: 19/670,001

(22) Filed: May 7, 2026

(30) Foreign Application Priority Data
May 14, 2025 (JP) 2025-081490

(51) Int. Cl. G06F 3/12

(52) U.S. Cl. CPC G06F 3/1205; G06F 3/1238; G06F 3/1257

(57) ABSTRACT

An application program capable of supporting a print setting suited to a device in cooperation with a printer driver, causes a computer to function as a print setting means that performs the print setting based on setting information for a first setting item that is able to be set by a user via a setting screen and setting information for a second setting item that is restricted from being set by the user via the setting screen, and a reception means that receives an operation to select a setting file containing the setting information for the second setting item, and the print setting means reads the setting information for the second setting item from the setting file received by the reception means and performs the print setting.

### FIELD OF THE INVENTION

The disclosure relates to an application program and the like. Note that the disclosure is based on JP 2025-081490 filed in Japan on May 14, 2025, the contents of which are incorporated herein by reference.

### Background Art

A printer driver supplied by a vendor that provides a printing apparatus is configured to maximize capabilities of the printing apparatus. However, the printer driver supplied by the vendor needs to be individually installed by a user who uses the printing apparatus. Therefore, for example, for a user who has difficulty in obtaining a printer driver because a network environment or the like is not prepared, it is difficult to introduce a printer driver supplied by a vendor.

On the other hand, a standard printer driver (hereinafter, simply referred to as a printer driver) incorporated in an operating system (OS) in advance does not need to be individually installed by the user who uses the printing apparatus. However, available functions are limited to standard functions in order to be compatible with various types of printing apparatuses.

In view of such circumstances, efforts have been made in recent years to fully utilize the capabilities of printing apparatuses by introducing print support applications (PSAs) that support printing using printer drivers.

### SUMMARY

### Technical Problem

The disclosure aims to provide an application program and the like that can apply appropriate settings to specific items for which execution of a print job becomes impossible when incorrect settings are made in printing processing using a PSA.

### Solution to Problem

In order to solve the above problem, an application program according to the disclosure, which is capable of supporting a print setting suited to a device in cooperation with a printer driver, causes a computer to function as a print setting means that performs the print setting based on setting information for a first setting item that is able to be set by a user via a setting screen and setting information for a second setting item that is restricted from being set by the user via the setting screen, and a reception means that receives an operation to select a setting file containing the setting information for the second setting item, and the print setting means reads the setting information for the second setting item from the setting file received by the reception means and performs the print setting.

A print setting method according to the disclosure, which is capable of supporting a print setting suited to a device in cooperation with a printer driver, includes performing the print setting based on setting information for a first setting item that is able to be set by a user via a setting screen and setting information for a second setting item that is restricted from being set by the user via the setting screen, receiving an operation to select a setting file containing the setting information for the second setting item, and performing the print setting by reading the setting information for the second setting item from the setting file received.

An information processing apparatus according to the disclosure includes a storage that stores an application program capable of supporting a print setting suited to a device in cooperation with a printer driver, and a controller that performs the print setting based on setting information for a first setting item that is able to be set by a user via a setting screen and setting information for a second setting item that is restricted from being set by the user via the setting screen, in which the controller receives an operation to select a setting file containing the setting information for the second setting item, and performs the print setting by reading the setting information for the second setting item from the setting file received.

### Advantageous Effects of Disclosure

According to the disclosure, it is possible to provide an application program and the like that can apply appropriate settings to specific items for which execution of a print job becomes impossible when incorrect settings are made in printing processing using a PSA.

### BRIEF DESCRIPTION OF THE DRAWINGS

FIG. 1 is a diagram for describing a connection configuration of an information processing apparatus according to a first embodiment.

FIG. 2 is a diagram for describing a functional configuration of the information processing apparatus according to the first embodiment.

FIG. 3A is a diagram for describing an example of a data structure of Device Containers.

FIG. 3B is a diagram for describing an authentication information file.

FIG. 4 is a diagram for describing a functional configuration of a printing apparatus according to the first embodiment.

FIG. 5 is a sequence diagram for describing printing processing using a printer driver and a PSA.

FIG. 6 is a flowchart for describing a flow of processing according to the first embodiment.

FIG. 7 is a diagram for describing an example of a data structure of a device management table.

FIG. 8 is a flowchart for describing a flow of processing according to the first embodiment.

FIG. 9 is a flowchart for describing a flow of processing according to the first embodiment.

FIG. 10A is a diagram for describing an operation example according to the first embodiment.

FIG. 10B is a diagram for describing an operation example according to the first embodiment.

FIG. 11 is a diagram for describing an operation example according to the first embodiment.

FIG. 12 is a diagram for describing an operation example according to the first embodiment.

FIG. 13 is a diagram for describing an operation example according to the first embodiment.

FIG. 14 is a diagram for describing an operation example according to the first embodiment.

FIG. 15 is a diagram for describing an operation example according to the first embodiment.

FIG. 16 is a diagram for describing an operation example according to the first embodiment.

FIG. 17 is a diagram for describing an operation example according to the first embodiment.

FIG. 18 is a diagram for describing an operation example according to the first embodiment.

FIG. 19 is a diagram for describing an operation example according to a second embodiment.

FIG. 20 is a diagram for describing an operation example according to the second embodiment.

FIG. 21 is a diagram for describing an operation example according to the second embodiment.

FIG. 22 is a diagram for describing an operation example according to the second embodiment.

### DESCRIPTION OF EMBODIMENTS

Hereinafter, embodiments of the disclosure will be described with reference to the drawings. The embodiments to be described below are merely examples for describing the disclosure, and the technical contents described in the claims are not limited to the following descriptions.

When controlling a printing apparatus such as a multifunction apparatus to process a print job, an information processing apparatus generates the print job via a dedicated printer driver installed in an operating system (OS) or a printer driver provided as a standard function of the OS. In general, the dedicated printer driver installed in the OS for use is provided for each printing apparatus by the vendor of printing apparatuses and is configured to fully utilize capabilities of the printing apparatus.

On the other hand, in order to provide versatility that enables printing on many (various) printing apparatuses, the printer drivers only support functions common to the printing apparatuses in many cases. Even when processing a print job using the printer driver, a print result similar to that obtained when using the dedicated printer driver has been recently required in many cases. In addition, in order to improve the stability and security of the OS, the vendor providing the OS has made an effort to expand the function of the printer driver.

As one aspect of the above effort, a PSA is known that supports processing of a print job by the printer driver. In general, the PSA is supplied as an application by the vendor or the like that provides the OS or the printing apparatus. The PSA is configured to cooperate with the printer driver so as to be able to fully exert the function of the printing apparatus based on obtained capability information of the printing apparatus. For example, the PSA can change a page description language (PDL) and add a print job language (PJL) command to the print job in accordance with a printer driver.

The Internet Printing Protocol (IPP) is known as a communication protocol for transmitting and receiving the print job and necessary information between the information processing apparatus and the printing apparatus. In the IPP, the print job is represented by print data (document data) in a predetermined PDL format and IPP attribute information. Here, the IPP attribute information includes, for example, specifications related to printer operations such as "Print-Job (print execution)" and "Get-Printer-Attributes (printer attribute acquisition)", specifications related to job operations such as "Get-Job-Attributes (job state acquisition)" and "Cancel-Job (job cancellation)" as well as attributes and values thereof (attribute values) that specify print settings, device settings, and output capabilities of the printing apparatus (e.g., number of copies that can be made, finisher type, print quality, etc.). The PSA communicates with the printing apparatus via a network based on the IPP to obtain capability information of the printing apparatus, and the printing apparatus can process the print job by analyzing the attribute values specified in the IPP attribute information.

When the PSA is associated with a printing apparatus on a network depending on the IPP, the PSA can display a setting screen (User Interface (UI)) suitable for the printing apparatus and receive print settings.

Here, when multiple printer drivers are available, for example, in a function of storing print data related to a print job in a specific storage device and printing or transmitting the stored print data as necessary (this function is referred to as document filing in some cases), a user needs to manually input a custom folder password for using a custom folder (referred to as a user folder in some cases) in which the print data is stored in this storage device, and authentication information for a user who logs in to a printing apparatus (e.g., a login name, a login password, a user number, etc.) (hereinafter, simply referred to as authentication information) each time for each desired printer driver. Here, when the authentication information needs to be input via the setting screen each time the printing apparatus to be used is changed or a new printer driver is used (updated), this input operation is troublesome and burdensome for the user. Further, for example, when there is an error in the input authentication information, or when authentication information different from the authentication information to be input is mistakenly input, the execution of the print job itself becomes impossible, thereby significantly reducing the convenience related to the use of the PSA.

It is preferable to restrict manual input by the user via the setting screen for specific items, such as the authentication information described above, for which execution of a print job is not allowed when an incorrect setting is made. By prompting the user to select a file containing setting information related to these specific items, it is expected that input errors in setting information related to these specific items will be reduced. Such an application program and the like that can apply appropriate settings to specific items are achieved in the following embodiments.

### 1 First Embodiment

### 1.1 Overall Configuration

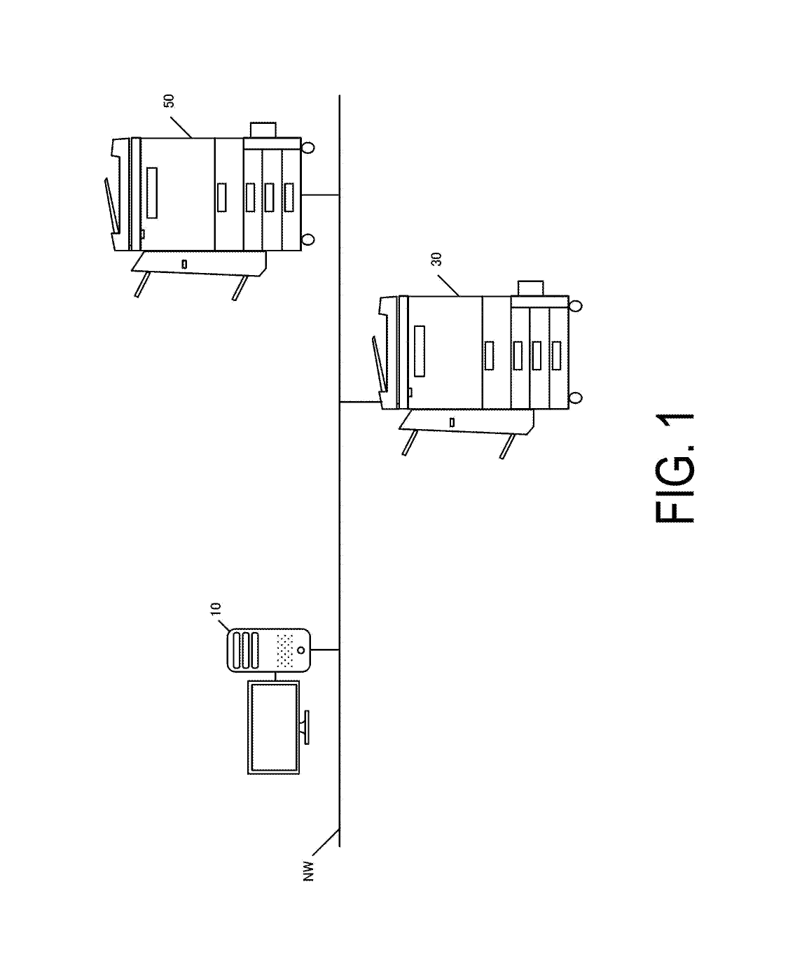

FIG. 1 is a diagram for describing an example of a connection configuration between a terminal device 10 as an information processing apparatus, a multifunction apparatus 30 as a printing apparatus, and a multifunction apparatus 50 as another printing apparatus, according to a first embodiment.

The terminal device 10 according to the first embodiment can be configured as a computer capable of operating based on a specific OS. The terminal device 10 can generate a print job based on a printer driver incorporated in the OS in advance and transmit the print job to the multifunction apparatus 30 or the multifunction apparatus 50 via a network NW. The multifunction apparatus 30 or the multifunction apparatus 50 is a printing apparatus that can perform various jobs such as printing, copying, faxing, and image transmission in a single housing. The multifunction apparatus 30 or the multifunction apparatus 50 is an example of a printing apparatus capable of forming an image on a recording paper based on a print job received from the terminal device 10.

FIG. 1 describes the configuration in which one multifunction apparatus 30 and one multifunction apparatus 50, which are printing apparatuses, are each connected to the network NW. However, the multifunction apparatus 30 and the multifunction apparatus 50 may be connected to another network NW (not illustrated) that is connected to the network NW, or multiple multifunction apparatuses 30 and multiple multifunction apparatuses 50 may be connected to the network NW. Further, the multifunction apparatus 30 or the multifunction apparatus 50 may be, for example, a printing apparatus specialized for a specific function, such as a printer or a fax machine. Note that when it is not necessary to distinguish between the multifunction apparatus 30 and the multifunction apparatus 50, the multifunction apparatus is simply referred to as the multifunction apparatus 30 or the like.

### 1.2 Functional Configuration

### 1.2.1 Terminal Device 10

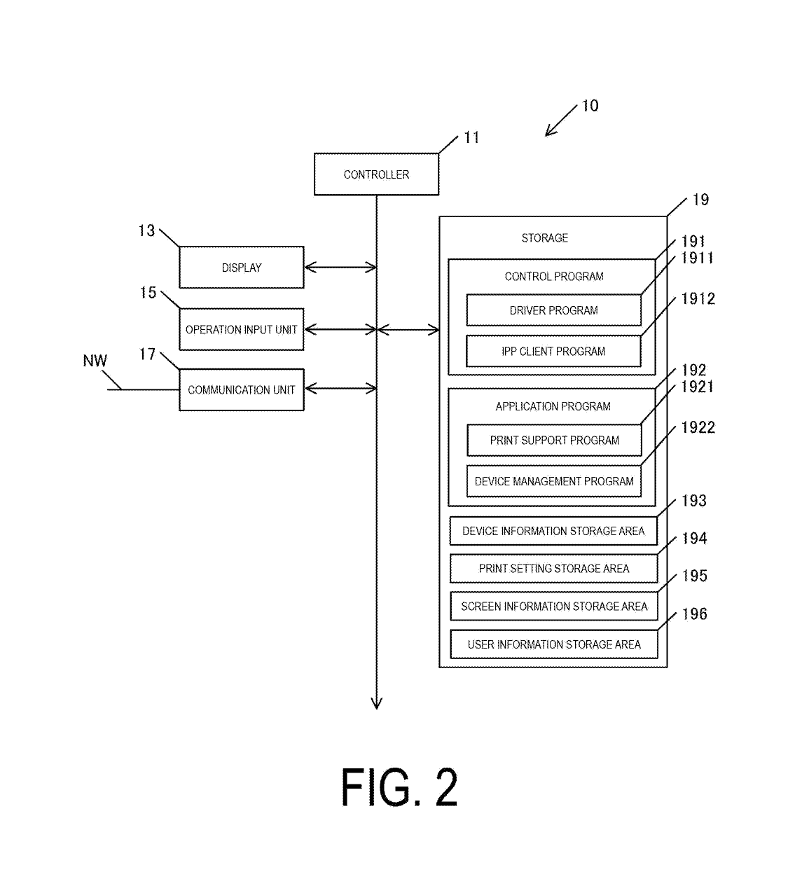

A functional configuration of the terminal device 10 will be described. FIG. 2 is a diagram for describing the functional configuration of the terminal device 10. The terminal device 10 includes a controller 11, a display 13, an operation input unit 15, a communication unit 17, and a storage 19.

The controller 11 controls the entire terminal device 10. The controller 11 is configured of, for example, one or multiple arithmetic devices (central processing units (CPUs) or the like). The controller 11 realizes its functions by reading and executing various programs stored in the storage 19.

The display 13 is a display device that displays various pieces of information to the user or the like. The display 13 can be configured of, for example, a liquid crystal display (LCD) or an organic electro-luminescence (EL) display.

The operation input unit 15 is an input device that receives information input by the user or the like. As the operation input unit 15, an input device such as a keyboard, a mouse, or a touch panel can be used.

The communication unit 17 includes a wired, wireless, or wired and wireless interface for communicating with another device (such as the multifunction apparatus 30) via, for example, a local area network (LAN), a wide area network (WAN), the Internet, a telephone line, or the like. Note that the communication unit 17 may include an interface for (short-range) wireless communication technology such as Bluetooth (registered trademark), near field communication (NFC), Wi-Fi (registered trademark), ZigBee (registered trademark), IrDA, or wireless USB.

The storage 19 is a storage device that stores various programs and various data necessary for operations of the terminal device 10. The storage 19 may be configured using a storage device such as a random access memory (RAM), a hard disk drive (HDD), a solid state drive (SSD), or a read only memory (ROM).

In the first embodiment, the storage 19 stores a control program 191 and an application program 192, and secures a device information storage area 193, a print setting storage area 194, a screen information storage area 195, and a user information storage area 196.

The control program 191 is a program that is read by the controller 11 when performing overall control of the terminal device 10. The controller 11 that has read the control program 191 functions as an OS, controls operation of hardware such as the display 13, the operation input unit 15 and the communication unit 17, starts and ends applications running on the OS, and manages files or the like. Further, when the controller 11 that has read the control program 191 detects a (new) connection with the multifunction apparatus 30 or the like based on, for example, a plug-and-play function or the like, the controller 11 executes processing (e.g., obtaining device information) necessary for recognizing and using the multifunction apparatus 30 or the like. The controller 11 manages the obtained device information in Device Containers to be described below.

The control program 191 includes a driver program 1911 and an IPP client program 1912. The driver program 1911 is a standard printer driver that operates on the OS. The IPP client program 1912 is a program that is read by the controller 11 when exchanging a print job with the multifunction apparatus 30 or the like based on the IPP. The controller 11 that has read the IPP client program 1912 searches for the multifunction apparatus 30 or the like and transmits a capability information acquisition request or a generated print job to the multifunction apparatus 30 or the like based on the IPP.

The application program 192 is a program that is read by the controller 11 upon receiving a start instruction from the user. The controller 11 that has read the application program 192 provides a specific function suited to the user's purpose, such as document creation, graphic drawing, and Internet browsing. Note that the application program 192 can be obtained by installation using a recording medium such as a CD or a DVD, by downloading from a service providing server (not illustrated), or the like.

The application program 192 includes a print support program 1921 and a device management program 1922. The print support program 1921 is a program that is read by the controller 11 to function as a PSA that doubles as a print setting means and a reception means, and works in cooperation with the printer driver to improve and enhance a print result. When starting up as a PSA, the controller 11 references Device Containers managed by the OS to obtain device information about the multifunction apparatus 30 or the like serving as a printing apparatus associated with the PSA. Here, the device information according to the disclosure is a character string that includes at least a vendor identifier (vendor ID) for identifying a vendor of the PSA, the multifunction apparatus 30, or the like, and a device identifier (device ID) for identifying the multifunction apparatus 30 or the like as a printing apparatus. Based on the obtained device information, the controller 11 generates a setting screen (UI) for receiving print settings suited to the multifunction apparatus 30 or the like and displays the setting screen on the display 13. The controller 11 stores the print settings received via the setting screen in the storage 19. Then, upon receiving input of a print execution instruction, the controller 11 generates a print job reflecting the stored print settings and transmits the print job to the target multifunction apparatus 30 or the like. The device management program 1922 is a program that is read by the controller 11 when managing obtained device information. The controller 11 that has read the device management program 1922 manages device information of the multifunction apparatus 30 or the like associated with the PSA and information accompanying the device information using a device management table to be described below.

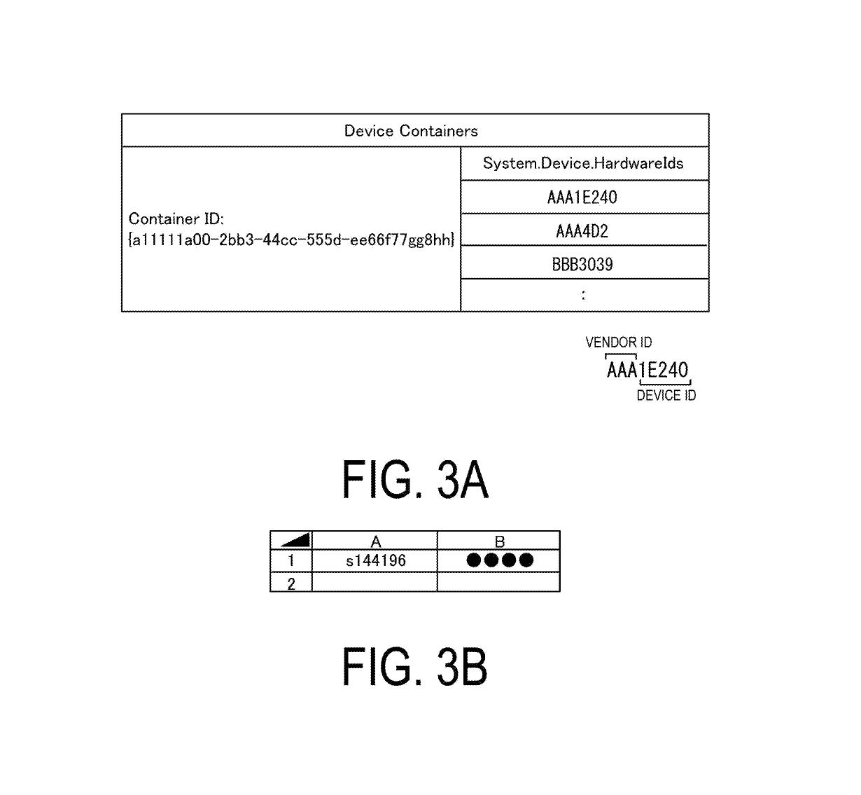

The device information storage area 193 is a storage area for storing device information (Device Containers) obtained by the OS from the multifunction apparatus 30 or the like, and a device management table managed by the controller 11 that has read the device management program 1922. Here, an example of a data structure of Device Containers according to the disclosure will be described with reference to FIG. 3A. Device Containers group device information necessary for recognizing and using devices (printing apparatuses) connected to the terminal device 10 in Container units.

FIG. 3A illustrates that Device Containers identified by Container ID (a11111a00-2bb3-44cc-555d-ee66f77gg8hh) include printing apparatuses ("AAA1E240" corresponding to the multifunction apparatus 30, "AAA4D2" corresponding to the multifunction apparatus 50, and "BBB3039" corresponding to another printing apparatus) as three types of devices.

Here, in System.Device.HardwareIds, first three digits represent a vendor ID, and fourth and subsequent digits represent a device ID. For example, in the case of AAA1E240, the vendor ID is "AAA", and the device ID is "1E240". Similarly, in the case of BBB3039, the vendor ID is "BBB", and the device ID is "3039". For example, in a case in which the PSA is an application provided by the vendor "AAA", the controller 11 obtains AAA1E240 and AAA4D2, which are assigned the vendor ID "AAA" as device information for the devices (printing apparatuses) associated with the PSA when starting the PSA.

Returning to FIG. 2 again, the print setting storage area 194 is a storage area for storing print settings suited to the printing apparatus received via the setting screen displayed by the PSA.

The screen information storage area 195 is a storage area for storing screen information (image/screen content) for a user interface (UI) screen such as a setting screen for receiving selection of the multifunction apparatus 30 or the like to execute printing processing, or a setting screen for receiving print settings suited to the multifunction apparatus 30 or the like.

The user information storage area 196 is a storage area for storing authentication information of a user who logs in to and operates the multifunction apparatus 30 or the like as an authentication information file. The authentication information file is a file in which authentication information such as a login name and a login password of the user for the multifunction apparatus 30 or the like is written. A file format of the authentication information file may be a general-purpose format, such as a CSV format, a text file format, a JSON format, or an XML format, or the authentication information file may be an encrypted file in which the authentication information is encrypted. For example, FIG. 3B is an example of an authentication information file expressed in the CSV format (Excel format) that contains a login name "s144196" in cell A1 and a login password "●●●●" in cell B1 as authentication information. When the user selects an authentication information file via the setting screen, Modified Setting Data to be described below is updated based on the authentication information contained in the selected authentication information file. Modified Setting Data updated is transmitted to the multifunction apparatus 30 or the like as IPP attribute information. Note that in the disclosure, the authentication information file is stored in the user information storage area 196, but the authentication information file may be stored in the print setting storage area 194. The user information storage area 196 may store user information about the user who operates the terminal device 10 (e.g., authentication information for the terminal device 10, attribute information such as name, telephone number, email address, and department), in addition to the authentication information file.

### 1.2.2 Multifunction Apparatus 30 and the Like

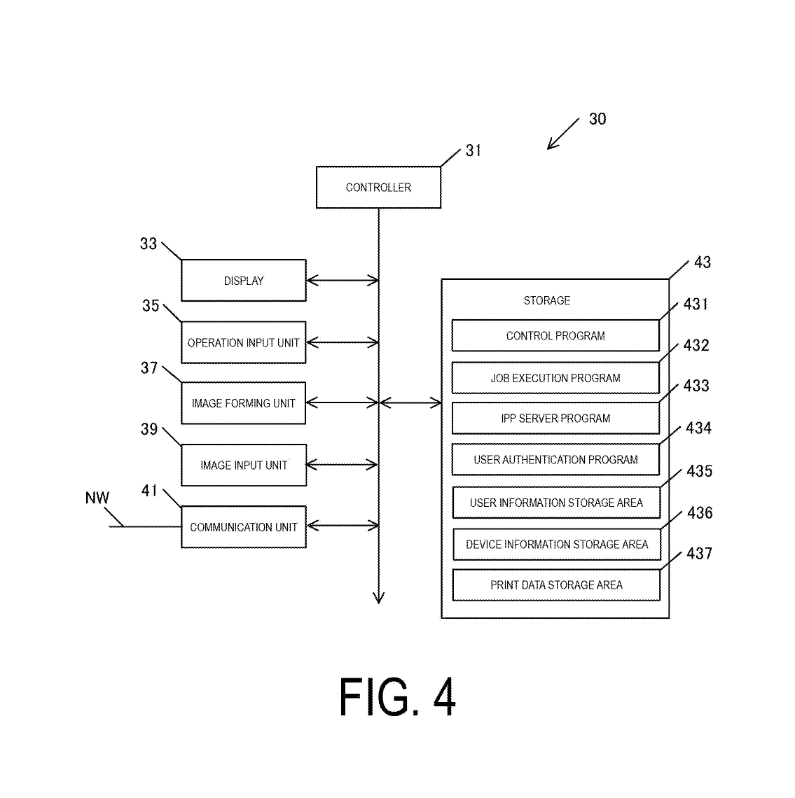

Next, a functional configuration of the multifunction apparatus 30 will be described. FIG. 4 is a functional configuration diagram of the multifunction apparatus 30. The multifunction apparatus 30 includes a controller 31, a display 33, an operation input unit 35, an image forming unit 37, an image input unit 39, a communication unit 41, and a storage 43. Note that the multifunction apparatus 50 is an apparatus different from the multifunction apparatus 30 and requires different print settings, and therefore, the following description will focus on a functional configuration common to both multifunction apparatuses.

The controller 31 controls the entire multifunction apparatus 30. The controller 31 is configured of, for example, one or multiple arithmetic devices (such as CPUs). The controller 31 implements functions thereof by reading and executing various programs stored in the storage 43.

The display 33 is a display device that displays various types of information to a user or the like. The display 33 can be configured using, for example, an LCD or an organic EL display.

The operation input unit 35 is an input device that receives input of information by the user or the like. The operation input unit 35 can be configured using, for example, various input devices such as operation keys (e.g., hardware keys and software keys) and buttons. Note that the operation input unit 35 can be configured as a touch panel that allows input via the display 33. In this case, as an input method for the touch panel, for example, a general method such as a resistance film method, an infrared beam method, an electromagnetic induction method, or an electrostatic capacitance method can be employed.

The image forming unit 37 feeds paper from a paper feed tray (not illustrated), forms an image on the paper based on document data included in a print job, and then discharges the paper to a paper discharge unit (not illustrated). The image forming unit 37 can be configured using, for example, a laser printer or the like that uses an electrophotographic system. In this case, the image forming unit 37 forms images using toners supplied from toner cartridges (not illustrated) corresponding to toner colors (e.g., cyan, magenta, yellow, black, etc.).

The image input unit 39 generates document data by scanning an original document. The image input unit 39 can be configured as a scanner device that is provided with an image sensor such as a charge coupled device (CCD) or a contact image sensor (CIS) and includes an automatic document feeder (ADF), a flatbed on which documents are placed to be read, and the like. The configuration of the image input unit 39 is not limited as long as the image input unit 39 can generate image data by reading a reflected light image from an original image using the image sensor. The image input unit 39 can also be configured as an interface that can obtain, for example, document data stored in a portable storage medium such as a universal serial bus (USB) flash drive or a print job transmitted from the terminal device 10.

The communication unit 41 includes, for example, one or both of wired and wireless interfaces for communicating with another device (the terminal device 10) via the network NW such as a LAN, a WAN, the Internet, a telephone line, or a fax line. In addition, the communication unit 41 may include an interface for (short-range) wireless communication technology such as Bluetooth (registered trademark), near field communication (NFC), Wi-Fi (registered trademark), ZigBee (registered trademark), IrDA, or wireless USB.

The storage 43 stores various programs and various data necessary for operation of the multifunction apparatus 30. The storage 43 can be configured using a storage device such as a RAM, an HDD, an SSD, or a ROM.

In the first embodiment, the storage 43 stores a control program 431, a job execution program 432, an IPP server program 433, and a user authentication program 434, and secures a user information storage area 435, a device information storage area 436, and a print data storage area 437.

The control program 431 is a program that is read by the controller 31 when performing overall control of the multifunction apparatus 30. The controller 31 that has read the control program 431 controls operation of the display 33, the operation input unit 35, the image forming unit 37, the image input unit 39, the communication unit 41, and the like.

The job execution program 432 is a program that is read by the controller 31 when executing a job such as printing, copying, faxing, or image transmission.

The IPP server program 433 is a program that is read by the controller 31 when exchanging print jobs with the terminal device 10 as a client device based on the IPP. The controller 31 that has read the IPP server program 433 obtains a response to a search from the terminal device 10, a response to a request to obtain capability information, or a print job transmitted from the terminal device 10.

The user authentication program 434 is a program that is read by the controller 31 when executing authentication processing based on the authentication information of the user assigned as IPP attribute information. The controller 31 that has read the user authentication program 434 authenticates the user by comparing the authentication information of the user (login name, login password, etc.) assigned as the IPP attribute information with the authentication information of the user registered and stored in advance in the user information storage area 435. When the authentication is successful, the controller 31 can store (hold) the print data related to the print job in the print data storage area 437. Then, when the user associated with the authenticated authentication information, that is, the user who has ownership of the print job and has transmitted the print job to the multifunction apparatus 30, logs in to the multifunction apparatus 30, the controller 31 can receive an instruction to execute a print job for the print data stored in the print data storage area 437.

The device information storage area 436 is a storage area for storing device information (device ID and apparatus information) of the multifunction apparatus 30.

The print data storage area 437 is a storage area for storing print data (document data) related to a print job.

### 1.3 Process Flow

### 1.3.1 Flow of Printing Processing Using Printer Driver and PSA

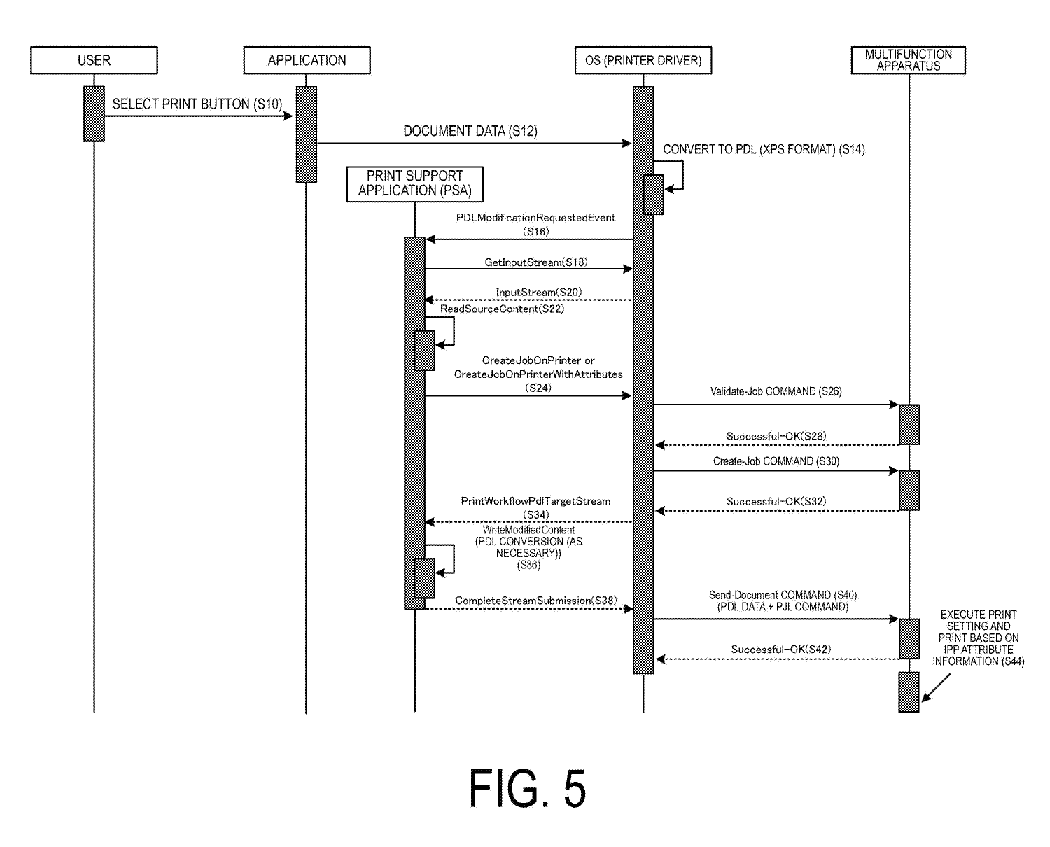

FIG. 5 is a sequence diagram for describing printing processing using a printer driver and a PSA. Note that FIG. 5 describes a mode in which the OS (printer driver) of the terminal device 10 outputs a print job to the multifunction apparatus 30.

First, the user selects a print button provided in a print dialog of an application (not illustrated) to print a document, a graphic, a web page, or the like created in the application such as document creation, graphics drawing, or Internet browsing (S10).

Upon receiving a selection of the print button, the application passes document data as print data corresponding to the created document, graphic, or the like to the OS (printer driver) (S12).

The OS (printer driver) converts the document data into PDL data (e.g., XPS format) (S14).

After converting the document data into the PDL data (e.g., XPS format), the OS (printer driver) executes PDLModificationRequestEvent of the PSA (S16).

The PSA requests the OS (printer driver) to obtain PDL data (XPS format) (S18).

Upon receiving the request to obtain the PDL data (XPS format), the OS (printer driver) passes the PDL data (XPS format) to the PSA (S20).

The PSA reads the obtained PDL data (XPS format) (S22), and requests the OS (printer driver) to generate a print job to be executed by the multifunction apparatus 30 or a print job with IPP attribute information attached (S24). At this time, the PSA may request the OS (printer driver) to generate a print job with IPP attribute information attached, based on print settings suited to the multifunction apparatus 30 to be described below.

The OS (printer driver) transmits a Validate-Job command to the multifunction apparatus 30 to confirm validity of the job (S26).

Upon receiving the Validate-Job command, the multifunction apparatus 30 transmits a Successful-OK status command to the OS (printer driver) according to the validity of the job (S28).

Upon receiving the Successful-OK status command, the OS (printer driver) transmits a Create-Job command for instructing job generation to the multifunction apparatus 30 (S30).

Upon receiving the Create-Job command, the multifunction apparatus 30 transmits a Successful-OK status command to the OS (printer driver) according to a reception status of the job generation (S32).

Upon receiving the Successful-OK status command from the multifunction apparatus 30, the OS (printer driver) passes a stream for printout to the PSA (S34).

The PSA that has obtained the stream for outputting the print job converts the PDL (XPS format) into a predetermined PDL such as a PDF format or a PCL6 format as necessary (S36).

The PSA inserts the PDL data (or the converted PDL data when converted to a specified PDL format) and a PJL command into the stream for printout obtained in S34, and notifies the OS (printer driver) of completion (S38).

The OS (printer driver) transmits the obtained PDL data and the obtained PJL command to the multifunction apparatus 30 using a Send-Document command (S40).

Upon receiving the Send-Document command, the multifunction apparatus 30 transmits a Successful-OK status command to the OS (printer driver), which indicates that the PDL data and the IPP attribute information have been received (S42). Then, upon receiving an instruction to execute a print job from the user, the multifunction apparatus 30 executes print settings including authentication processing based on the IPP attribute information, and executes printing (S44).

### 1.3.2 Flow of Processing Associated with PSA Startup

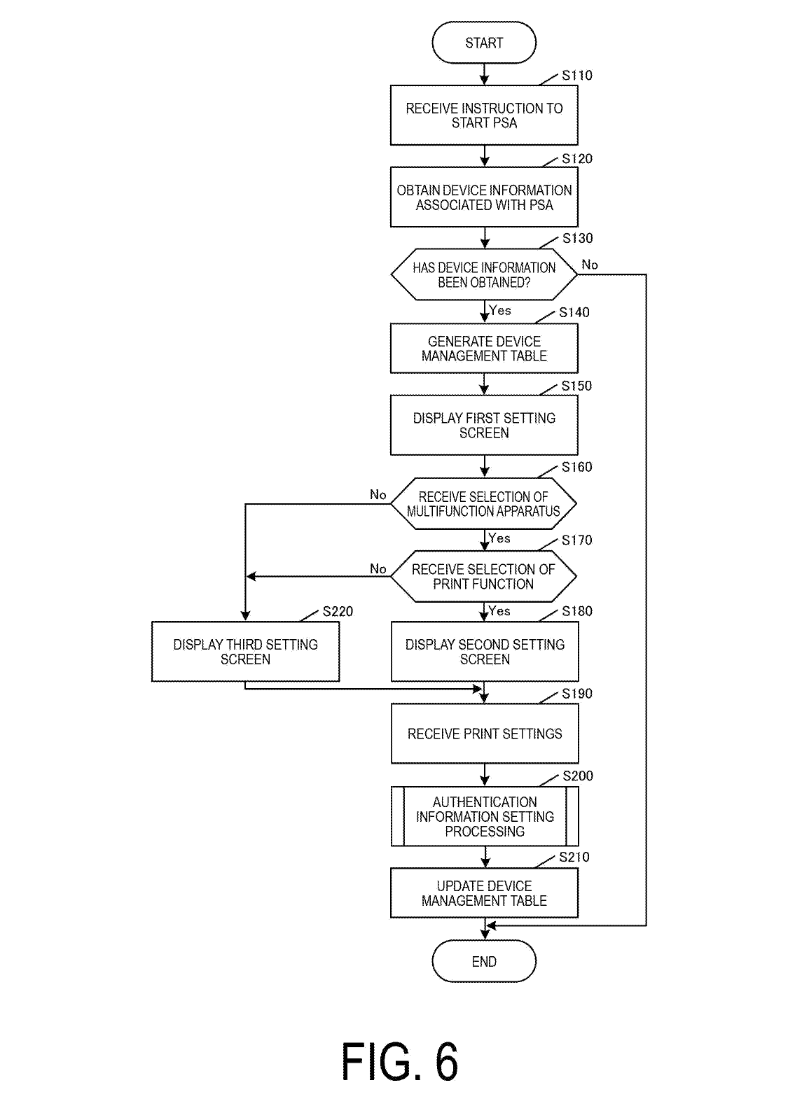

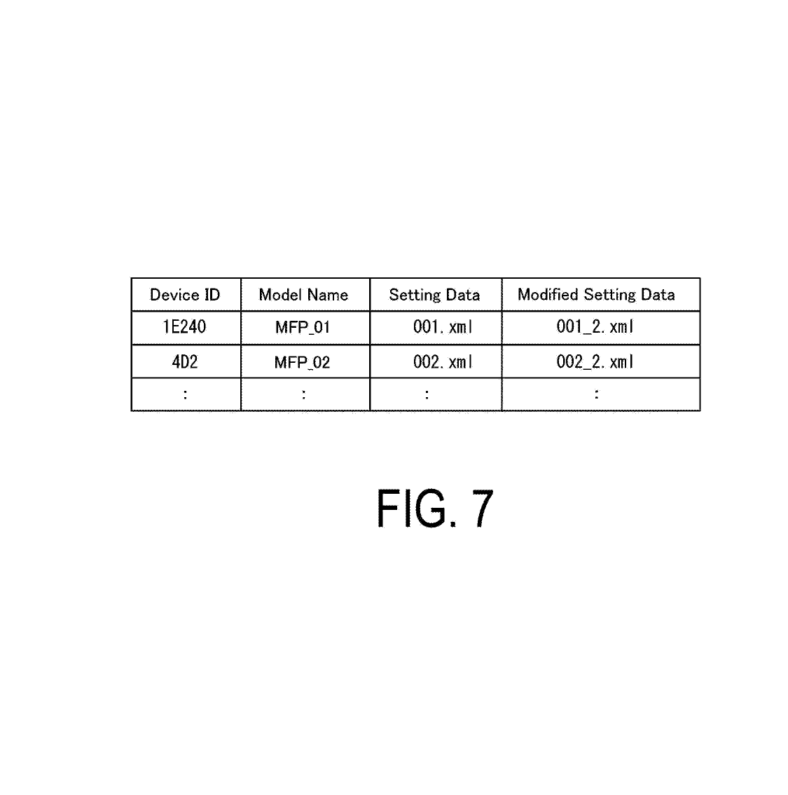

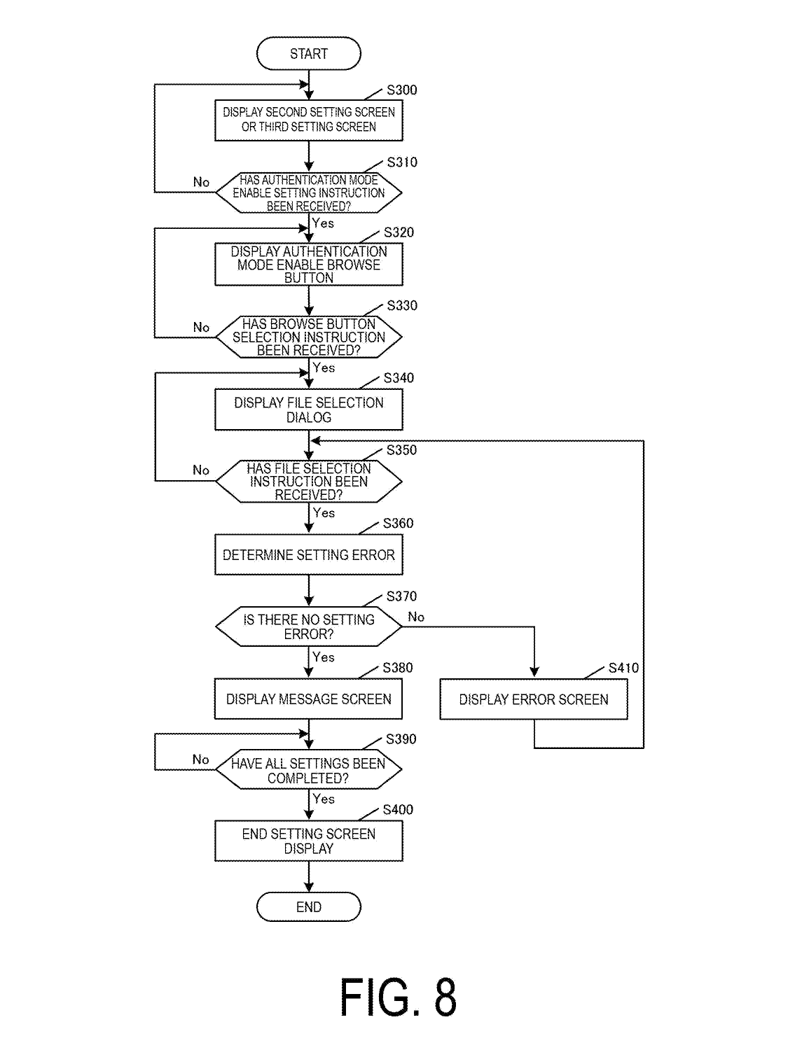

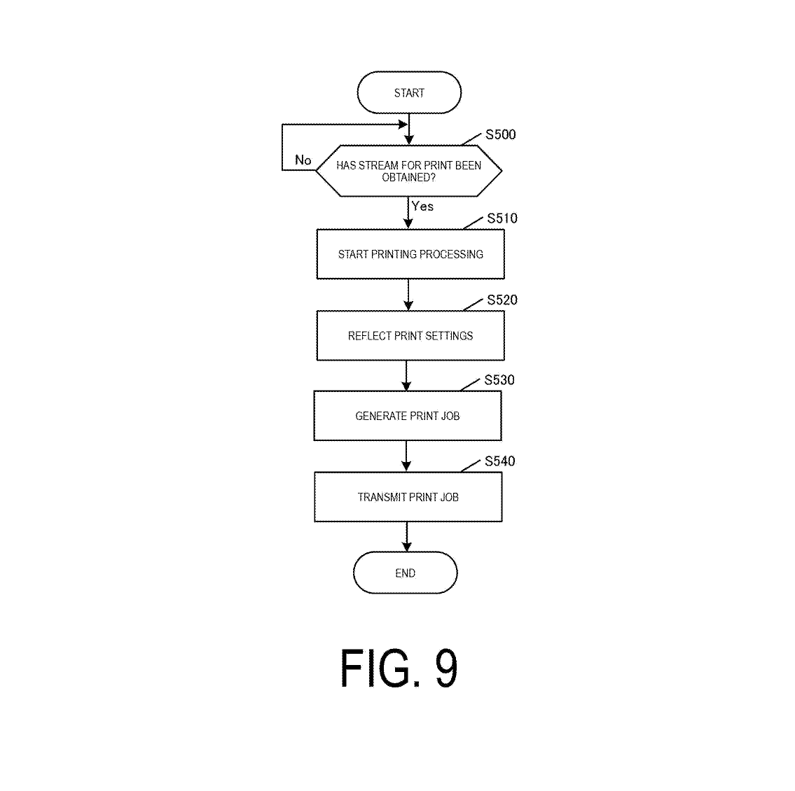

Next, a flow of processing according to the first embodiment will be described with reference to FIGS. 6 - 9. FIG. 6 is a flowchart for describing processing executed by the controller 11 of the terminal device 10 when the PSA is started, as the flow of processing according to the first embodiment. FIG. 7 is a diagram for describing an example of a data structure of a device management table. FIG. 8 is a flowchart for describing processing for setting authentication information, which is an example of a second setting item as a specific item. FIG. 9 is a flowchart for describing processing for outputting a print job using the generated device management table. The controller 11 of the terminal device 10 executes processing operations described in FIGS. 6, 8, and 9 by reading the print support program 1921, the device management program 1922, and the like.

In FIG. 6, the controller 11 receives an input of an instruction to start the PSA, for example, when a PSA icon included in a start menu (not illustrated) is selected or when the printer driver is set up (step S110).

The controller 11 starts the PSA by reading the print support program 1921. When the PSA is started, the controller 11 obtains device information of the multifunction apparatus 30 and the like associated with the PSA by referencing System.Devices.HardwareIDs in Device Containers illustrated in FIG. 3A (step S120).

If the device information associated with the PSA can be obtained from Device Containers, the controller 11 generates a device management table (step S130; Yes → step S140). Note that in this processing, it is assumed that the PSA is an application provided by the vendor "AAA", and that "AAA1E240" corresponding to the multifunction apparatus 30 and "AAA4D2" corresponding to the multifunction apparatus 50 are obtained as the device information of the multifunction apparatuses associated with this PSA.

On the other hand, if the device information associated with the PSA cannot be obtained, the controller 11 ends the processing (step S130; No → End).

Subsequently, the controller 11 displays a first setting screen on the display 13 for receiving selection of the multifunction apparatus 30 or the like for which print settings are to be stored (managed) based on the generated device management table (step S150).

The controller 11 determines whether selection of either the multifunction apparatus 30 or the multifunction apparatus 50 has been received via the first setting screen (step S160). If the controller 11 determines that either the multifunction apparatus 30 or the multifunction apparatus 50 has been selected via the first setting screen, the controller 11 determines whether a print function that can be implemented by the selected one of the multifunction apparatus 30 and the multifunction apparatus 50 has been selected (S160; Yes → step S170).

If the controller 11 determines that the print function that can be implemented by the selected one of the multifunction apparatus 30 and the multifunction apparatus 50 has been selected, the controller 11 displays a second setting screen for the selected print function on the display 13 (step S170; Yes → step S180).

However, if the selection of the multifunction apparatus 30 or the multifunction apparatus 50 is not received via the first setting screen (step S160; No) or if the selection of the print function that can be implemented by the selected one of the multifunction apparatus 30 and multifunction apparatus 50 is not received (step S170; No), the controller 11 displays a third setting screen on the display 13 (step S220) that includes the setting items (print functions) of all multifunction apparatuses (in this case, both the multifunction apparatus 30 and the multifunction apparatus 50) related to the device information obtained in step S130.

The controller 11 receives the print settings corresponding to the received print function via the second setting screen or the third setting screen (step S190). Subsequently, the controller 11 executes processing for setting the authentication information, which is an example of a second setting item as a specific item (step S200). The controller 11 updates the device management table generated in step S140 based on the print settings received in step S190 and step S200, and then ends the processing (step S210).

Here, the device management table generated by the controller 11 in step S140 in FIG. 6 will be described. FIG. 7 is a diagram for describing an example of a data structure of the device management table. Note that the device management table may be in a table format as illustrated in FIG. 7, or may be a database.

The device management table includes the following management items: Device ID, Model Name, Setting Data, and Modified Setting Data. Note that in FIG. 7, the multifunction apparatus 30 (the device information "AAA1E240") and the multifunction apparatus 50 (the device information "AAA4D2") are used as the multifunction apparatuses associated with the PSA (see FIG. 3A).

Device ID is a portion corresponding to the device ID in the obtained device information. For example, Device ID "1E240" corresponds to the device ID "1E240" obtained from the device information "AAA1E240". Model Name represents a model name of the multifunction apparatus 30, "MFP_01". Setting Data represents a data set of print settings "001.xml" that contains default setting values to be applied on the print setting screen. Modified Setting Data represents a data set "001_2.xml" that contains setting values that have been changed from the default values related to Setting Data (see step S200 in FIG. 6).

Similarly, Device ID "4D2" corresponds to the device ID "4D2" obtained from the device information "AAA4D2". Model Name represents a model name of the multifunction apparatus 50, "MFP_02". Setting Data represents a data set of print settings "002.xml" that contains default setting values to be applied on the print setting screen. Modified Setting Data represents a data set "002_2.xml" that contains setting values that have been changed from the default values related to Setting Data (see step S200 in FIG. 6).

Next, the processing for setting the authentication information, which is an example of the second setting item as a specific item in step S200 in FIG. 6, will be described in detail with reference to the flowchart in FIG. 8.

The controller 11 displays the second setting screen or the third setting screen (step S300; corresponding to step S180 or step S220 in FIG. 6).

Then, the controller 11 determines whether an instruction to enable an authentication mode as a first setting item that can be set by the user via the setting screen has been received via the second setting screen or the third setting screen (step S310). If it is determined that the instruction to enable the authentication mode has been received, the controller 11 enables the authentication mode and displays a browse button for receiving an instruction to select an authentication information file for setting the authentication information, which is the second setting item (step S310; Yes → step S320). On the other hand, if it is determined that the instruction to enable the authentication mode has not been received, the controller 11 continues to display the second setting screen or the third setting screen until the instruction to enable the authentication mode is received (step S310; No → step S300).

The controller 11 determines whether the instruction to select the browse button by the user has been received (step S330). If it is determined that the instruction to select the browse button by the user has been received, the controller 11 displays a file selection dialog for receiving an instruction to select the authentication information file (step S330; Yes → step S340). If it is determined that the instruction to select the browse button by the user has not been received, the controller 11 continues to display the browse button (step S330; No → step S320).

Subsequently, the controller 11 determines whether an instruction to select the authentication information file has been received from the user via the file selection dialog (step S350). If it is determined that the instruction to select the authentication information file from the user has been received, the controller 11 reads the authentication information contained in the selected authentication information file and determines whether read authentication information contains a setting error (step S350; Yes → step S360). The determination of the setting error in the authentication information can be performed, for example, by comparing the authentication information read from the authentication information file with genuine authentication information stored in a storage area (not illustrated) that cannot be changed or tampered with. In this case, the authenticity of the authentication information read from the authentication information file may be determined by comparing binary values representing the authentication information or hash values calculated using a hash function. Alternatively, the multifunction apparatus 30 or the like that is a destination of the print job may be queried as to whether the authentication information read from the authentication information file is correct. When the multifunction apparatus 30 or the like is queried as to whether the authentication information is correct, the authentication processing by reading the user authentication program 434 may be omitted.

If there is no error in the authentication information read from the authentication information file, the controller 11 displays a message screen (step S370; Yes → step S380) to be described below. Subsequently, the controller 11 determines whether all (printing) settings have been completed (step S390). If it is determined that all settings have been completed, the controller 11 ends the display of the second setting screen or the third setting screen and ends the series of processing operations (step S390; Yes → step S400).

On the other hand, if there is an error in the authentication information read from the authentication information file, the controller 11 displays an error screen to be described below, and returns the processing to step S350 (step S370; No → step S410 → step S350).

Next, processing for outputting a print job using the device management table generated in step S140 in FIG. 6 will be described with reference to FIG. 9. The processing described in FIG. 9 is processing corresponding to the sequence from S20 to S40 described in FIG. 5.

The controller 11 determines whether a stream for print has been obtained (step S500). If it is determined that the stream for print has been obtained, the controller 11 starts the printing processing (step S510). Note that if it is determined that the PDL data has not been obtained, the controller 11 waits until the PDL data is obtained (step S500; No).

The controller 11 updates Modified Setting Data based on the authentication information (login name, password, etc.) read from the authentication information file selected by the user, and assigns the updated Modified Setting Data as IPP attribute information, thereby reflecting the print settings suited to the multifunction apparatus 30 or the like (step S520).

Subsequently, the controller 11 generates a print job to which the IPP attribute information has been assigned (step S530), transmits the generated print job to the multifunction apparatus 30 or the like selected in step S160 in FIG. 6, and ends the processing (step S540).

### 1.4 Operation Example

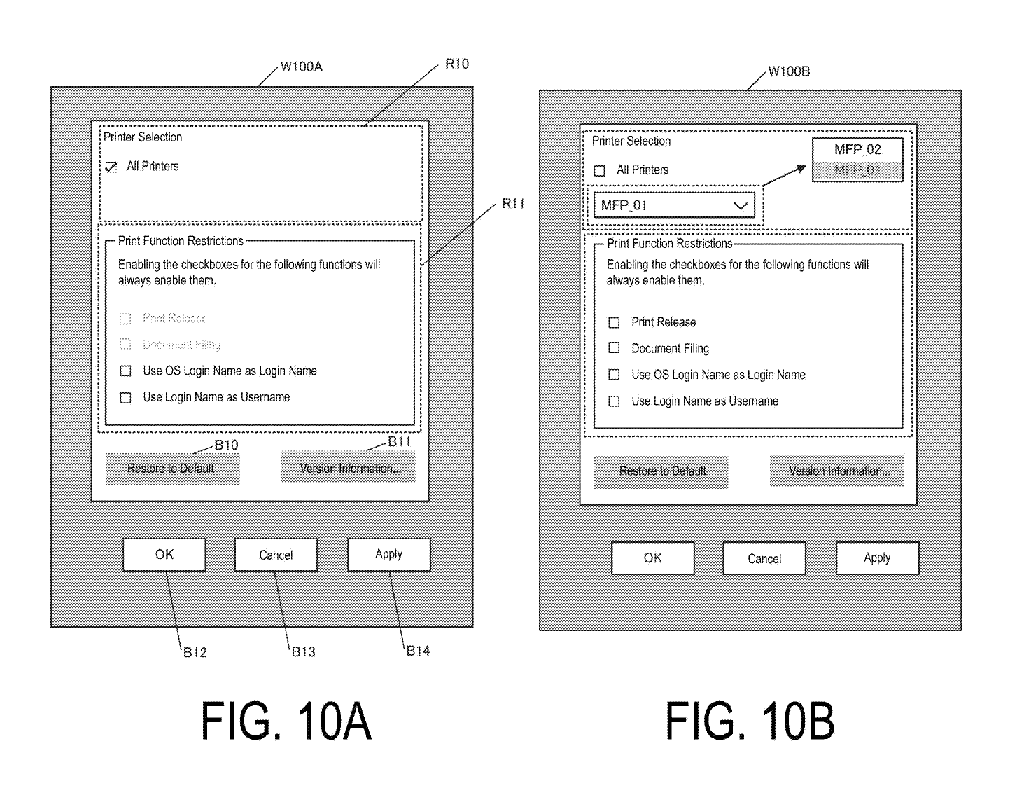

Next, an operation example according to the first embodiment is described. FIGS. 10A and 10B are diagrams for describing a startup screen W100 as the first setting screen that the controller 11 displays on the display 13 when the PSA is started, and are operation examples corresponding to the processing of step S150 in FIG. 6. The startup screen W100 transitions to either a startup screen W100A (FIG. 10A) or a startup screen W100B (FIG. 10B) depending on whether the devices for which print settings are to be stored (managed) are all multifunction apparatuses associated with the PSA (the multifunction apparatus 30 and the multifunction apparatus 50) or one multifunction apparatus associated with the PSA (the multifunction apparatus 30 or the multifunction apparatus 50).

Note that screen configurations of both the startup screen W100A and the startup screen W100B can be the same. Thus, in the following description, reference numerals are assigned only to the startup screen W100A.

The startup screen W100A includes a printer selection area R10, a function restriction area R11, a "Restore to Default" button B10, a "Version Information" button B11, an "OK" button B12, a "Cancel" button B13, and an "Apply" button B14.

The printer selection area R10 is an area that includes a device selection item that receives selection of a multifunction apparatus for which print settings are to be stored (managed). The printer selection area R10 includes an "All Printers" checkbox. The "All Printers" checkbox is a checkbox that receives selection of all multifunction apparatuses associated with the PSA for which print settings are to be stored (managed). When the "All Printers" checkbox is checked and required print functions are selected in the function restriction area R11, and then either the "OK" button B12 or the "Apply" button B14 is selected, the controller 11 determines that the multifunction apparatuses for which print settings to be stored (managed) are all multifunction apparatuses associated with the PSA.

On the other hand, when the "All Printers" checkbox is not checked, the controller 11 displays a pull-down menu for selecting one multifunction apparatus associated with the PSA, as illustrated on the startup screen W100B. FIG. 10B illustrates an example in which the devices named "MFP-01" (the multifunction apparatus 30) and "MFP-02" (the multifunction apparatus 50) are displayed as selectable multifunction apparatuses, and the device named "MFP-01" (the multifunction apparatus 30) is selected as the multifunction apparatus for which print settings are to be stored (managed).

The function restriction area R11 is an area including function selection items that receive selection of whether to enable or disable print functions that can be implemented by the selected multifunction apparatus (the multifunction apparatus 30 or the multifunction apparatus 50). The print functions displayed as selectable in the function restriction area R11 can be changed as appropriate according to the result of selecting the multifunction apparatus in the printer selection area R10. For example, when "All Printers" is selected in the printer selection area R10, print functions that cannot be implemented by some multifunction apparatuses selected as all printers may be included. In such cases, as illustrated in FIG. 10A, it is possible to control the display so that the print functions that cannot be implemented are grayed out and cannot be selected as print functions to be enabled (e.g., print release, document filing, etc.). In FIG. 10A (FIG. 10B), four types of print functions, "Print Release", "Document Filing", "Use OS Login Name as Login Name", and "Use Login Name as Username", are illustrated as print functions that are displayed as selectable options in the function restriction area R11, but the print functions that can be displayed in the function restriction area R11 are not limited to these. For example, it is certainly possible to include print functions that can be implemented by the printer driver alone, such as color/monochrome printing, double-sided/single-sided printing, and print finishing functions (stapling, hole punching, etc.).

The "Restore to Default" button B10 is a button that receives selection of restoring the settings made in the printer selection area R10 and the function restriction area R11 to default values. The "Version Information" button B11 is a button that receives an instruction to display version information of the PSA.

The "OK" button B12 is a button that receives an instruction to confirm the settings made in the printer selection area R10 and the function restriction area R11. When the "OK" button B12 is selected, the controller 11 receives the settings made in the printer selection area R10 and the function restriction area R11, and ends the display of the startup screen W100A or the startup screen W100B. The "Cancel" button B13 is a button that receives an instruction to cancel the settings made in the printer selection area R10 and the function restriction area R11. The "Apply" button B14 is a button that receives an instruction to confirm the settings made in the printer selection area R10 and the function restriction area R11. When the "Apply" button B14 is selected, the controller 11 receives the settings made in the printer selection area R10 and the function restriction area R11, but continues to display the startup screen W100A or the startup screen W100B.

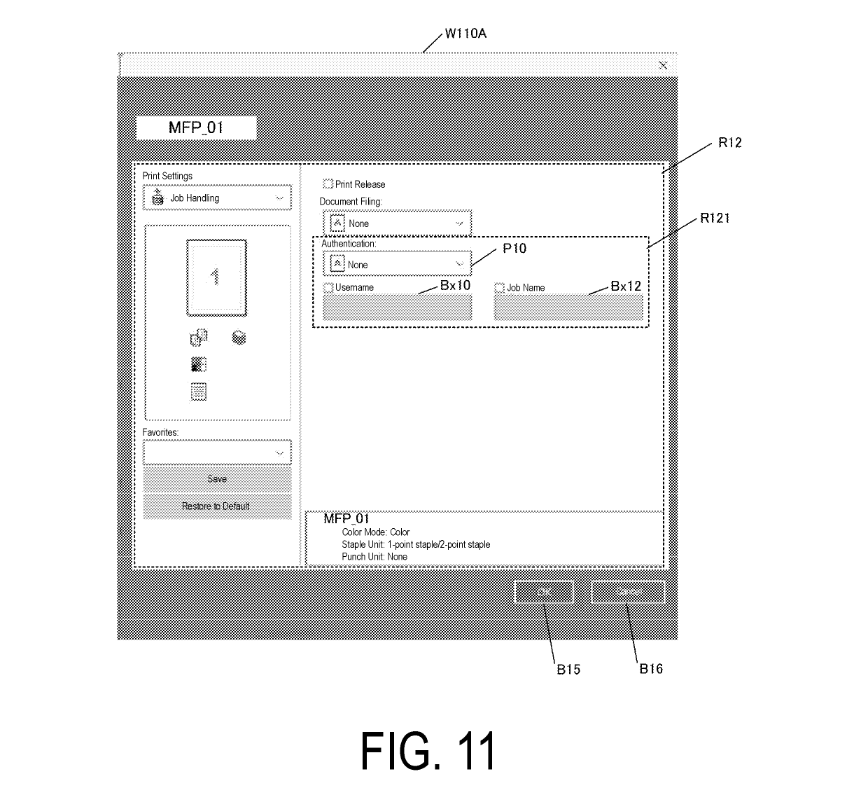

FIG. 11 is a diagram describing an example of a display configuration of a print setting screen W110A displayed by the controller 11 as a third setting screen when the device named "MFP-01" (the multifunction apparatus 30) is selected in the printer selection area R10 of the startup screen W100B in FIG. 10B as the multifunction apparatus for which print settings to be stored (managed), but in this case, no specific print function to be enabled is selected in the function restriction area R11, and is an operation example corresponding to the processing of step S220 in FIG. 6.

The print setting screen W110A includes a print setting area R12 that can display all setting items related to the print functions (job handling) of the device named "MFP-01" (the multifunction apparatus 30). In FIG. 11, since no specific print function is selected in the function restriction area R11 on the startup screen W100B of FIG. 10B, all setting items related to the print functions, such as "Print Release", "Document Filing", "Use OS Login Name as Login Name", and "Use Login Name as Username", are displayed.

The print setting area R12 includes a user authentication function setting area R121 that receives settings related to the user authentication function. The user authentication function setting area R121 is a setting area that receives a setting of authentication information, which is an example of a second setting item. The user authentication function setting area R121 includes a pull-down menu P10 for receiving an instruction to switch between enabling and disabling the user authentication function, a username input box Bx10, and a job name input box Bx12.

The pull-down menu P10 is an example of the first setting item that can be set by the user via the setting screen, and allows the user to select one of the following authentication methods as the user authentication method: "Login Name", "Login Name/Password", "User Number", and "None". In the first embodiment, when the authentication method "Login Name/Password" is selected as the first setting item, the authentication information such as the login name and the password, which are the second setting items for which the user is restricted from setting via the setting screen, is restricted from being manually input by the user, and the selection of an authentication information file containing this authentication information is received, thereby making it possible to set appropriate authentication information. Note that a display configuration of the setting screen when the authentication method "Login Name/Password" is selected as the first setting item will be described below.

The username input box Bx10 is an input box that receives input of a username to be displayed on the operation screen. When the user checks a checkbox located above the input box, the username input box Bx10 is activated, thereby allowing input of a username. Note that when the print function related to "Use Login Name as Username" is selected in the function restriction area R11 of FIG. 10A or 10B, the login name is automatically input as the username in the username input box Bx10. The job name input box Bx12 is an input box that receives input of a job name (file name) to be displayed on the operation screen. When a checkbox located above the input box is checked, the job name input box Bx12 is activated, thereby allowing input of a job name. Note that input into the username input box Bx10 and the job name input box Bx12 is optional, and the user can input into these input boxes as needed.

The print setting area R12 also includes a "Save" button and a "Restore to Default" button. The "Save" button is a button that receives an instruction to save the print settings corresponding to the print functions set or changed in the print setting area R12. Upon receiving selection of the "Save" button, the controller 11 stores the print settings corresponding to the print functions received in the print setting area R12 as Modified Setting Data. The "Restore to Default" button is a button that receives an instruction to restore the print settings corresponding to the print functions set or changed in the print setting area R12 to default values. Upon receiving selection of the "Restore to Default" button, the controller 11 returns the print settings corresponding to the print functions received in the print setting area R12 to the default values, and stores the print settings as Setting Data.

The "OK" button B15 is a button that receives an instruction to confirm the settings on the print setting screen W110. The "Cancel" button B16 is a button that receives an instruction to cancel the settings on the print setting screen W110.

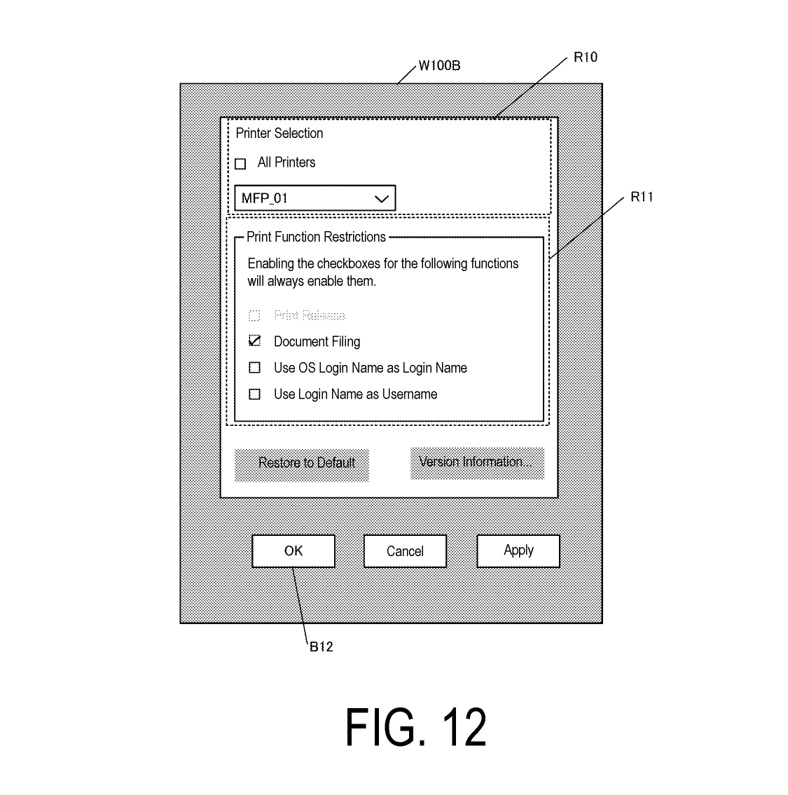

FIG. 12 is a diagram describing a state when the device named "MFP-01" (the multifunction apparatus 30) is selected in the printer selection area R10 of the startup screen W100B in FIG. 10B as the multifunction apparatus for which print settings are to be stored (managed), and "Document Filing" is selected in the function restriction area R11 as a specific print function to be enabled.

When "Document Filing" is selected as the specific print function to be enabled in the function restriction area R11 and then the "OK" button B12 is selected, the controller 11 displays a print setting screen W110B, which omits the setting items related to the selected print function "Document Filing", as the second setting screen.

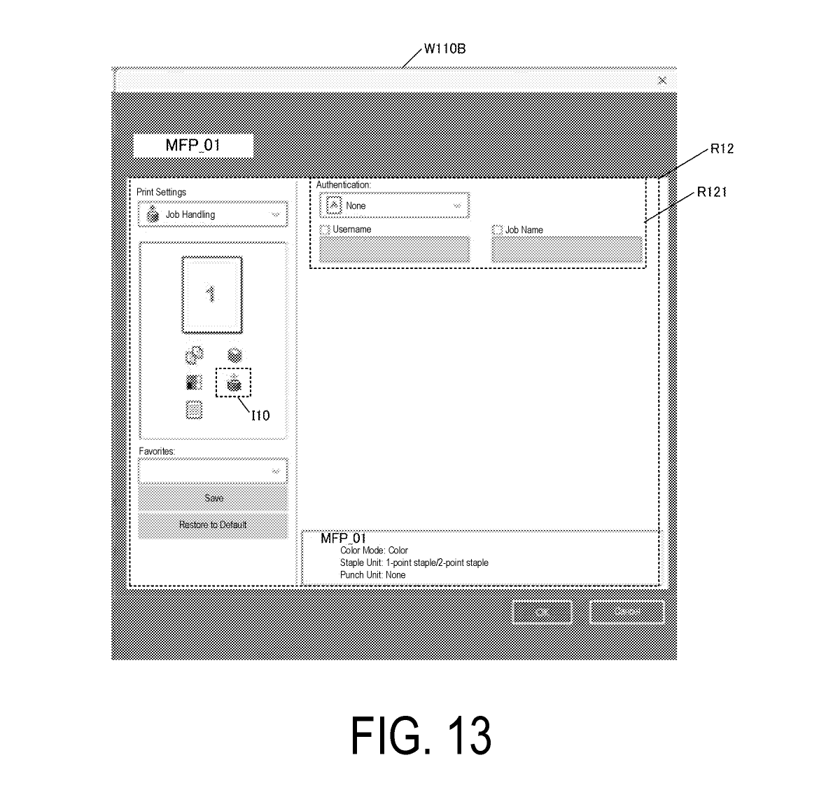

FIG. 13 illustrates an example of a display configuration of the print setting screen W110B. On the print setting screen W110B, print settings relating to the print function "Document Filing" is omitted, but an icon I10 indicating that this print function is enabled is displayed. The user can understand that the print function "Document Filing" is enabled by checking a figure represented by the icon I10. Note that the rest of the configuration of the print setting screen W110B can be the same as the configuration of the print setting screen W110A, so that detailed description thereof is omitted here.

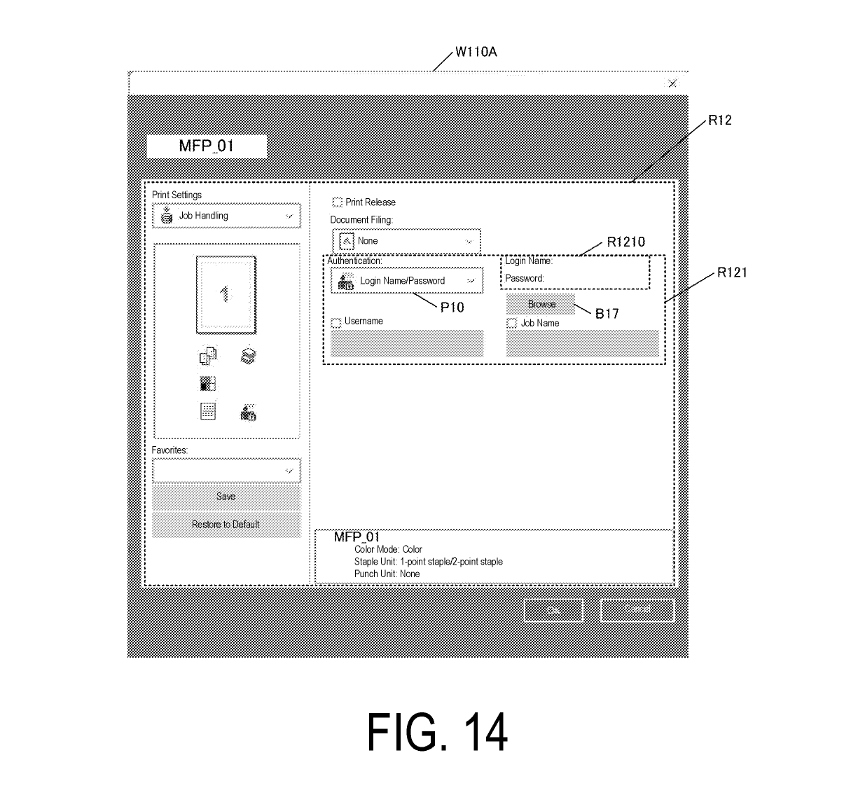

Next, the setting of the user authentication function via the print setting screen W110A as the third setting screen illustrated in FIG. 11 will be described with reference to FIGS. 14 to 18. The operation examples described with reference to FIGS. 14 to 18 correspond to the processing operations described with reference to the flowchart of FIG. 8. Note that FIGS. 14 to 18 describe the configuration of the setting of the user authentication function via the print setting screen W110A, which is the third setting screen. However, since the setting of the user authentication function can be set via the print setting screen W110B, which is the second setting screen illustrated in FIG. 13, in a similar manner, detailed description thereof will be omitted.

FIG. 14 is a diagram describing a state when the user selects "Login Name/Password" as the authentication method via the pull-down menu P10 in the user authentication function setting area R121 on the print setting screen W110A. Upon receiving an instruction to select "Login Name/Password" as the authentication method, the controller 11 displays a login name/password display area R1210 and a browse button B17 in the user authentication function setting area R121.

The login name/password display area R1210 is a display area for displaying authentication information such as a login name and a password of a user. The authentication information displayed in the login name/password display area R1210 corresponds to the second setting item, so that manual input by the user is restricted. Therefore, the login name/password display area R1210 is displayed blank before an authentication information file is selected via the browse button B17.

The browse button B17 is a selection button that receives an instruction to select the authentication information file from the user. Upon receiving the instruction to select the browse button B17 from the user, the controller 11 displays a file selection dialog, which will be described in the following figure.

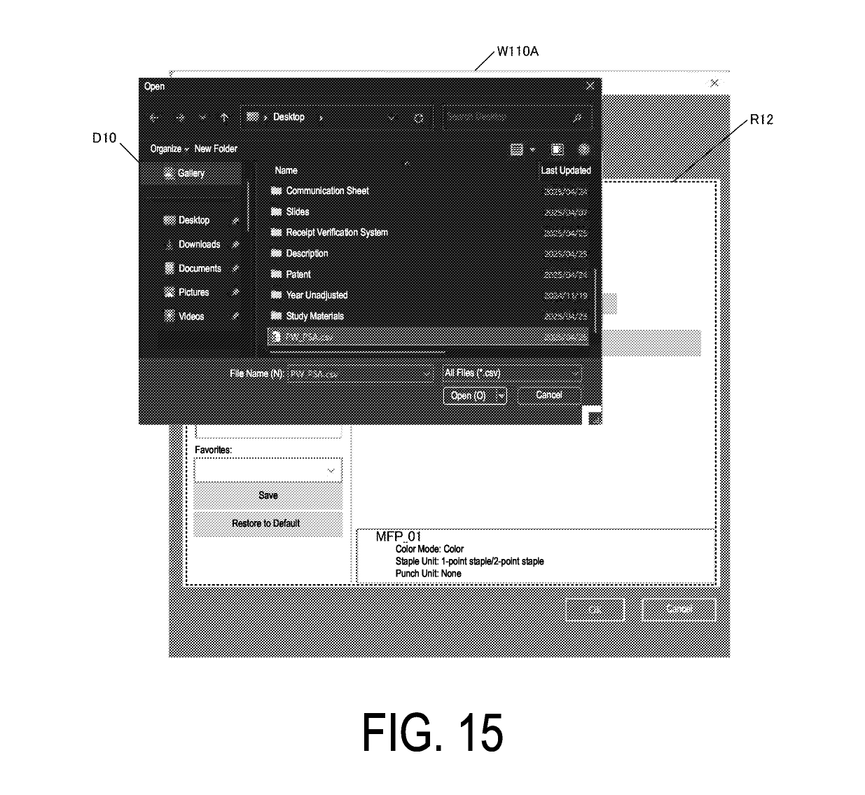

FIG. 15 is a diagram for describing an example of a display configuration of a file selection dialog D10 displayed by the controller 11 when receiving the instruction to select the browse button B17 from the user. FIG. 15 illustrates that the user has selected "PW_PSA.csv" as the authentication information file.

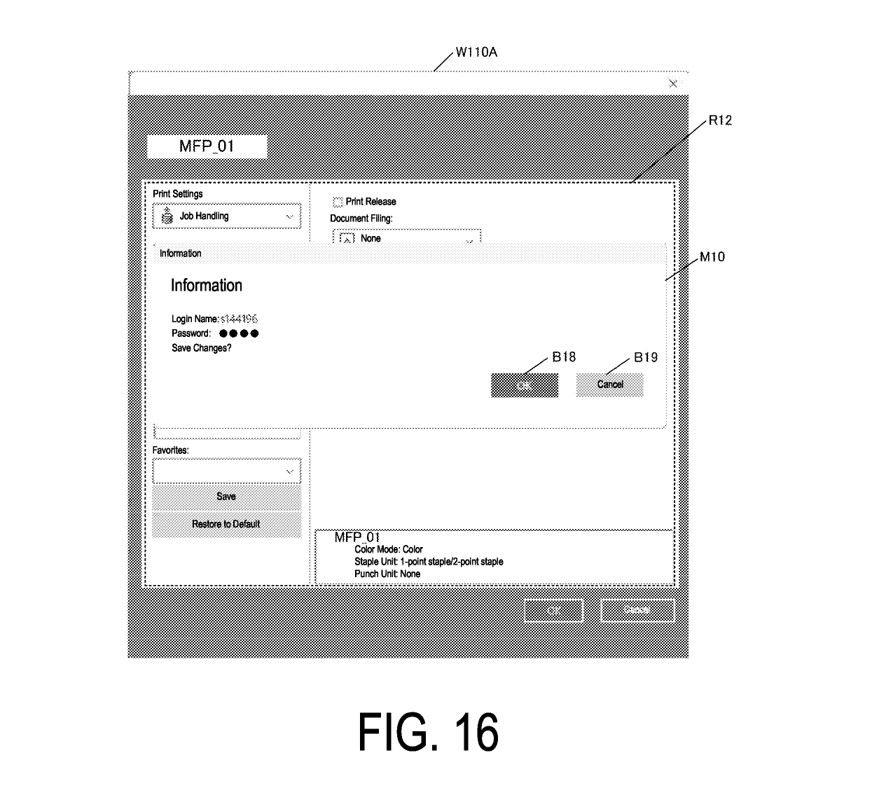

FIG. 16 is a diagram for describing an example of a display configuration of a message screen M10 displayed by the controller 11 when the user selects the authentication information file and no setting errors are found in this authentication information file (in FIG. 8, step S370; Yes → step S380). The message screen M10 includes a message inquiring whether to change (apply) and save the authentication information (login name: s144196, password: ●●●●) read from the authentication information file selected by the user, an "OK" button B18, and a "Cancel" button B19. The "OK" button B18 is a selection button that receives an instruction to confirm the change to the authentication information. The "Cancel" button B19 is a selection button that receives an instruction to cancel the change to the authentication information. Upon receiving an instruction to select the "OK" button B18 from the user, the controller 11 ends the display of the message screen M10 and applies the authentication information read from the authentication information file selected by the user as the authentication information to be applied to the user authentication function. On the other hand, upon receiving an instruction to select the "Cancel" button B19 from the user, the controller 11 ends the display of the message screen M10, and cancels the change of the authentication information. In this case, the controller 11 may redisplay the file selection dialog D10 illustrated in FIG. 15.

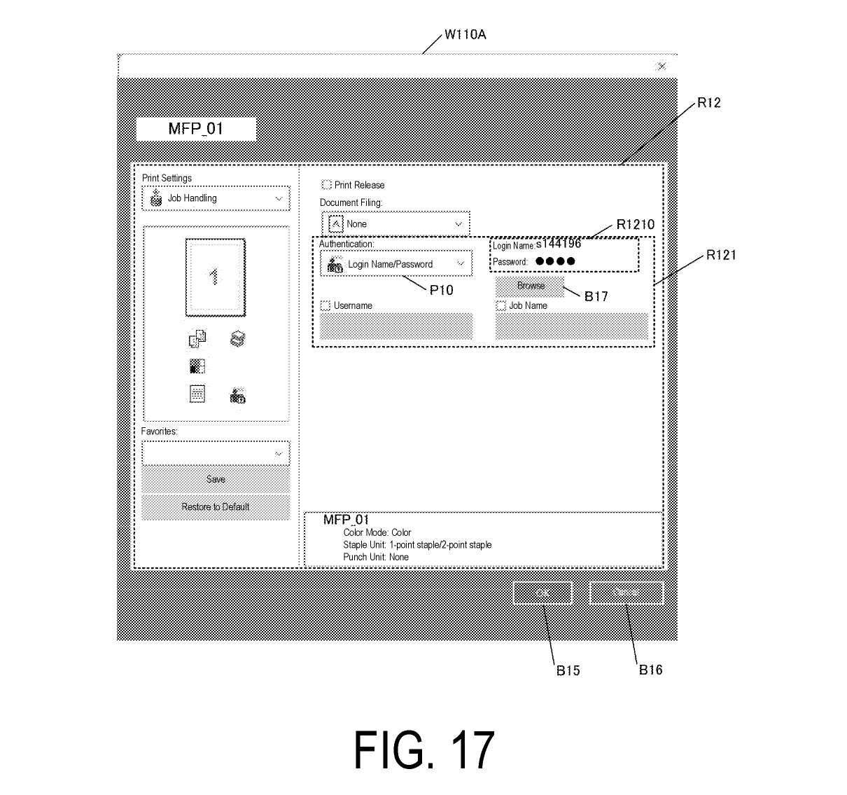

FIG. 17 is a diagram for describing an example of a display configuration of the print setting screen W110A displayed by the controller 11 when receiving an instruction to select the "OK" button B18 on the message screen M10 illustrated in FIG. 16. The display configuration of the print setting screen W110A illustrated in FIG. 17 is identical to the display configuration of the print setting screen W110A illustrated in FIG. 14, and thus detailed description thereof will be omitted here. The print setting screen W110A illustrated in FIG. 17 describes a state in which the authentication information (login name: s144196, password: ●●●●) contained in the authentication information file selected by the user is applied to the login name/password display area R1210.

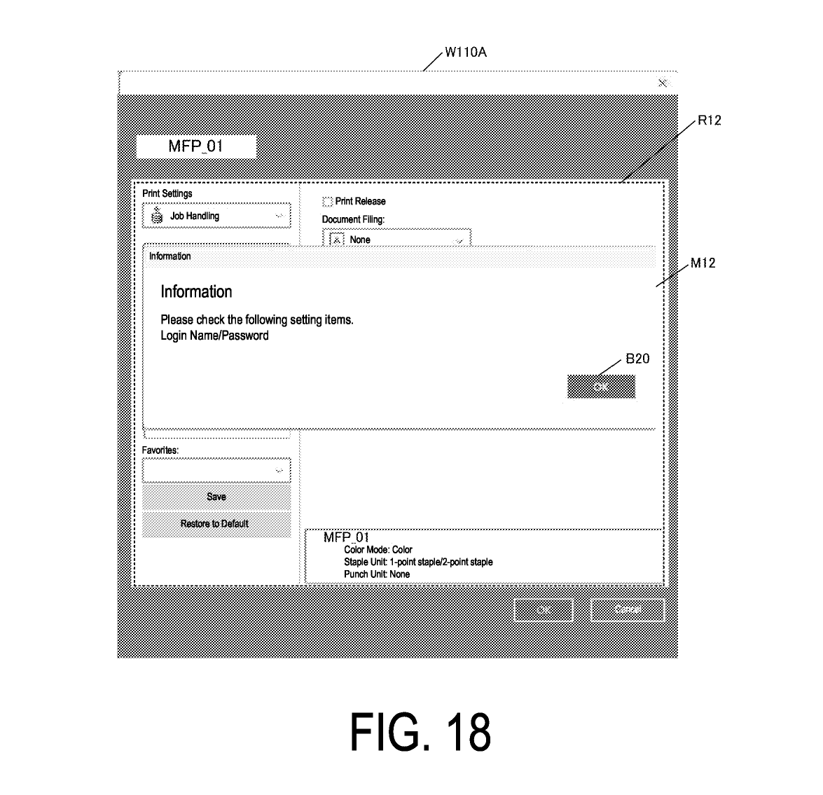

On the other hand, FIG. 18 is a diagram describing an example of a display configuration of an error screen M12 displayed by the controller 11 when there is a setting error in the authentication information read from the authentication information file selected by the user (in FIG. 8, step S370; No → step S410). The error screen M12 includes a message stating that there is a setting error in the authentication information contained in the selected authentication information file and prompting the user to check the details (Please check the following setting items: Login Name/Password) and an "OK" button B20. The "OK" button B20 is a selection button for receiving an instruction to confirm the message content from the user. Upon receiving an instruction to select the "OK" button B20 from the user, the controller 11 ends the display of the error screen M12. In this case, the controller 11 may redisplay the file selection dialog D10 illustrated in FIG. 15.

### 2 Second Embodiment

In the first embodiment, a configuration in which the authentication method "Login Name/Password" is selected as the first setting item is described. In a second embodiment, a configuration in which an authentication method "User Number" is selected as a first setting item will be described.

An overall configuration, a functional configuration, and a flow of processing according to the second embodiment can be similar to those according to the first embodiment, so that detailed description thereof will be omitted here.

### 2.1 Operation Example

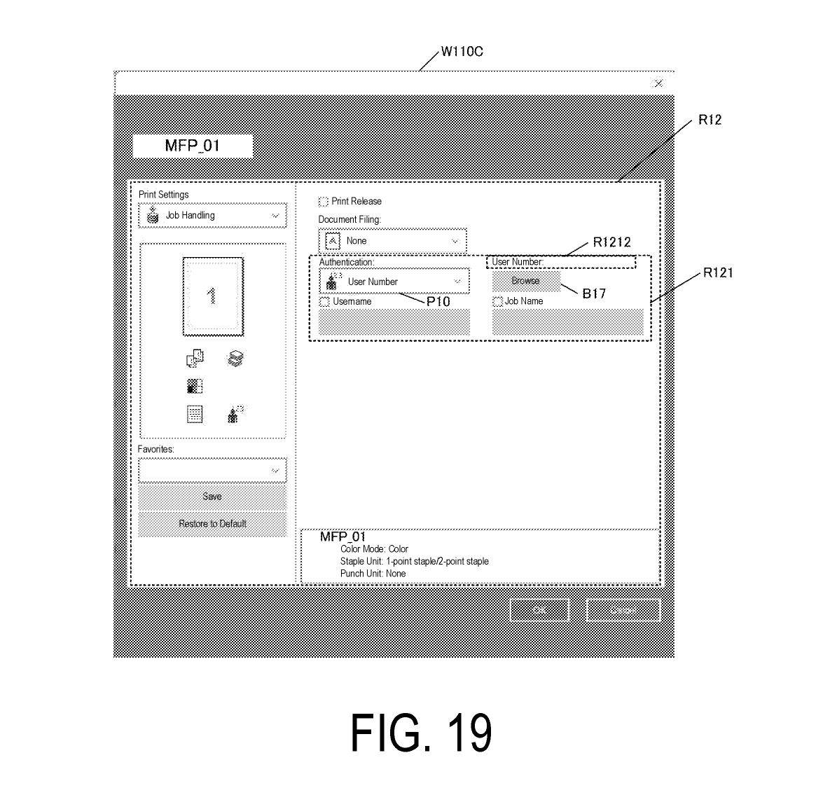

Next, operation examples according to the second embodiment will be described. FIG. 19 is a diagram for describing an example of a display configuration of a print setting screen W110C displayed as a third setting screen according to the second embodiment. The print setting screen W110C can have the same configuration as the print setting screen W110A illustrated in FIG. 14 and other figures in the first embodiment, so that the same configurations are denoted by the same symbols, and detailed description thereof will be omitted here.

The print setting screen W110C illustrated in FIG. 19 describes a state in which a user has selected "User Number" as an authentication method via a pull-down menu P10 in a user authentication function setting area R121. Upon receiving an instruction to select "User Number" as the authentication method, a controller 11 displays a user number display area R1212 and a browse button B17 in the user authentication function setting area R121.

The user number display area R1212 is a display area that displays the user number as authentication information assigned to a user. The authentication information displayed in the user number display area R1212 corresponds to a second setting item, so that manual input by the user is restricted. Therefore, the user number display area R1212 is displayed blank before an authentication information file is selected via the browse button B17.

The browse button B17 is a selection button that receives an instruction to select the authentication information file from the user. Upon receiving the instruction to select the browse button B17 from the user, the controller 11 displays a file selection dialog illustrated in FIG. 15.

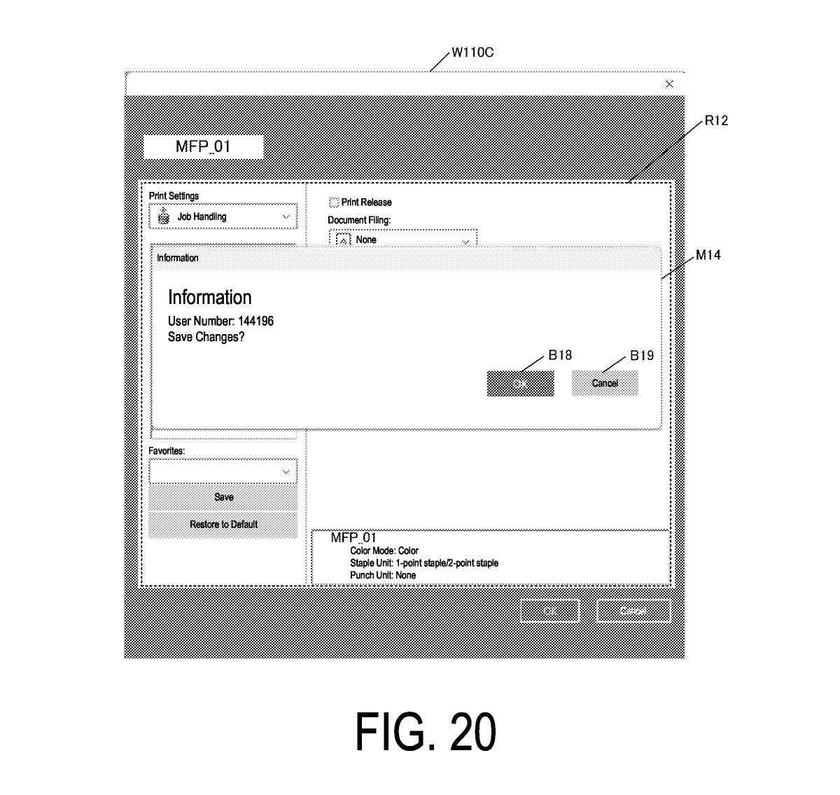

FIG. 20 is a diagram for describing an example of a display configuration of a message screen M14 displayed by the controller 11 when the user selects the authentication information file and no setting errors are found in this authentication information file (in FIG. 8, step S370; Yes → step S380). The message screen M14 includes a message inquiring whether to change (apply) and save the authentication information (user number: 144196) read from the authentication information file selected by the user, an "OK" button B18, and a "Cancel" button B19. The "OK" button B18 is a selection button that receives an instruction to confirm the change to the authentication information. The "Cancel" button B19 is a selection button that receives an instruction to cancel the change to the authentication information. Upon receiving an instruction to select the "OK" button B18 from the user, the controller 11 ends the display of the message screen M14 and applies the authentication information read from the authentication information file selected by the user as the authentication information to be applied to the user authentication function. On the other hand, upon receiving an instruction to select the "Cancel" button B19 from the user, the controller 11 ends the display of the message screen M14, and cancels the change of the authentication information. In this case, the controller 11 may redisplay the file selection dialog D10 illustrated in FIG. 15.

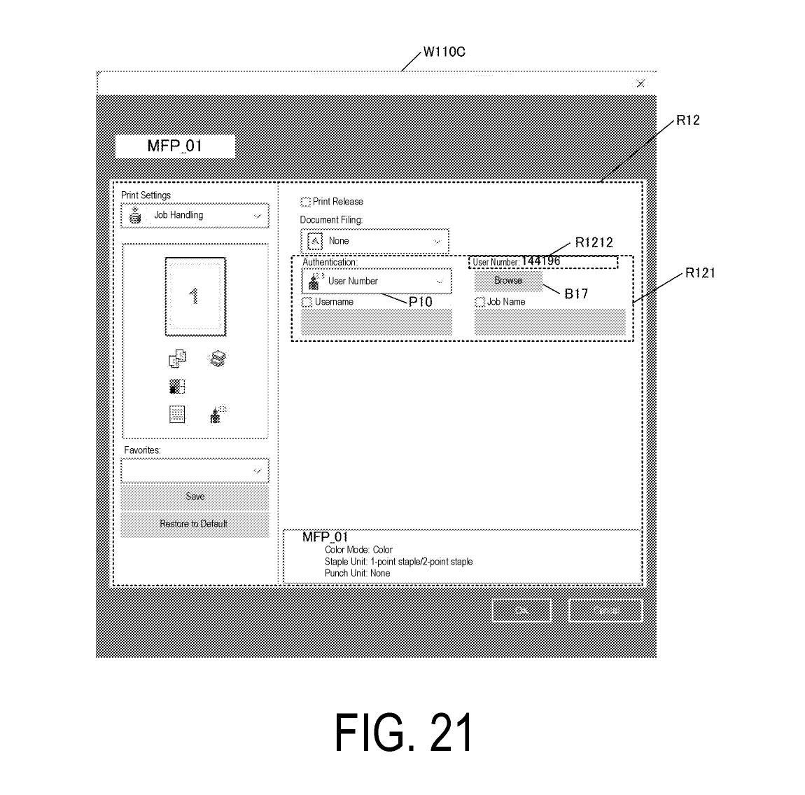

FIG. 21 is a diagram for describing an example of a display configuration of the print setting screen W110C displayed by the controller 11 when receiving the instruction to select the "OK" button B18 on the message screen M14 illustrated in FIG. 20. The display configuration of the print setting screen W110C illustrated in FIG. 21 is identical to the print setting screen W110C illustrated in FIG. 19, and thus detailed description thereof will be omitted here. The print setting screen W110C illustrated in FIG. 21 describes a state in which the authentication information (user number: 144196) contained in the authentication information file selected by the user is applied to the user number display area R1212.

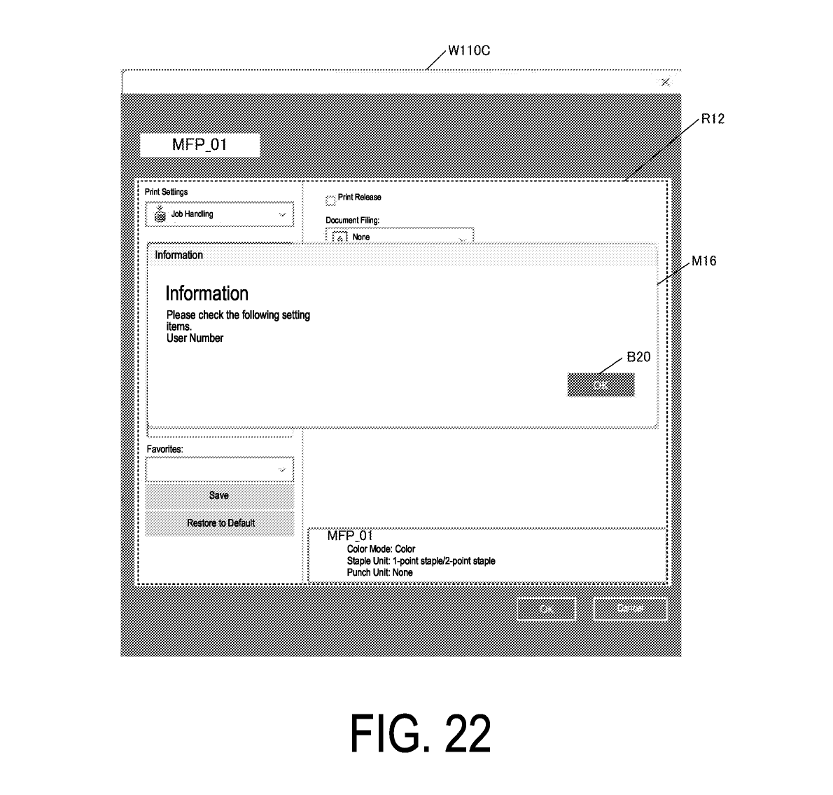

On the other hand, FIG. 22 is a diagram describing an example of a display configuration of an error screen M16 displayed by the controller 11 when there is a setting error in the authentication information read from the authentication information file selected by the user (in FIG. 8, step S370; No → step S410). The error screen M16 includes a message stating that there is a setting error in the authentication information contained in the selected authentication information file and prompting the user to check the details (Please check the following setting items: User Number) and an "OK" button B20. The "OK" button B20 is a selection button for receiving an instruction to confirm the message content from the user. Upon receiving an instruction to select the "OK" button B20 from the user, the controller 11 ends the display of the error screen M16. In this case, the controller 11 may redisplay the file selection dialog D10 illustrated in FIG. 15.

As described above, according to the embodiments of the disclosure, input information (authentication information) is saved as the authentication information file, so that appropriate setting can be made even when, for example, input information (authentication information) such as a password is forgotten. In addition, for example, even when the multifunction apparatus 30 or the like to be used is changed, the user does not need to manually input the information, and can make appropriate settings by simply loading the authentication information file. Further, even when multiple printer drivers are used, the user does not need to manually input information, and can make the appropriate settings by simply loading the authentication information file. Furthermore, since the input information (authentication information) can be saved in the authentication information file, it is possible to prevent an erroneous manual input by the user. In addition, when inputting different custom folder password or authentication information for each print job, by creating an authentication information file for each print job, the user does not need to memorize the authentication information, and can simply load the authentication information file to make the appropriate settings.

The disclosure is not limited to the embodiments described above and can be modified in various ways. That is, embodiments obtained by combining appropriately modified technical means within the scope not departing from the gist of the disclosure are also included within the technical scope of the disclosure.

Further, although the above-described embodiments are described separately for convenience of description, it is obvious that the embodiments may be executed in combination within a technically possible scope.

Further, in the embodiments, a program operating on each apparatus is a program that controls a CPU or the like (a program for causing a computer to function) to realize the functions of the above-described embodiments. Information handled by such an apparatus is temporarily stored in a temporary storage device (for example, a RAM) during the process and then stored in various storage devices such as read only memories (ROMs) and HDDs, and is read, modified, and written by the CPU as necessary.

Herein, a computer-readable non-transitory recording medium on which a program for an information processing apparatus is recorded may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), or Blu-ray Disc (registered trademark) (BD)), a magnetic recording medium (for example, a magnetic tape or flexible disc), and the like. In this case, the program recorded on the recording medium is read by the computer of the information processing apparatus and executed by the computer, such that not only the functions of the above-described embodiment are enabled, but also functions of the disclosure are enabled by performing processing in cooperation with an operating system, another application program, or the like based on instructions of the program.

Further, when a program is distributed in a market, the program can be stored in a portable recording medium and distributed, or can be transferred to a server computer connected via a network such as the Internet. In this case, it is obvious that a storage device of the server computer is also included in the disclosure.

Further, each functional block or feature of the apparatus used in the above-described embodiments can also be implemented and executed by an electric circuit, for example, an integrated circuit or a plurality of integrated circuits. The electric circuit designed to enable the functions described herein may include a general-purpose processor, a Digital Signal Processor (DSP), an Application-Specific Integrated Circuit (ASIC), a Field Programmable Gate Array (FPGA), another programmable logic device, a discrete gate or transistor logic, a discrete hardware component, or a combination thereof. The general-purpose processor may be a microprocessor or may be a known processor, controller, microcontroller, or state machine. The electric circuit described above may include a digital circuit or an analog circuit. Further, when an integrated circuit technology for replacement into a current integrated circuit emerges with the development of semiconductor technology, a new integrated circuit based on the technology may also be used in one or more aspects of the disclosure.

What is claimed is :

1. A print setting method that supports a print setting suited to a device in cooperation with a printer driver, the print setting method comprising:
performing the print setting based on setting information for a first setting item that is set by a user via a setting screen and setting information for a second setting item that is restricted from being set by the user via the setting screen;
receiving an operation to select a setting file containing the setting information for the second setting item; and
performing the print setting by reading the setting information for the second setting item from the setting file received.

2. The print setting method according to claim 1, wherein
a file format of the setting file is a general-purpose format.

3. The print setting method according to claim 2, wherein
a file format of the setting file is a text file format.

4. The print setting method according to claim 1, wherein
the first setting item is a setting item related to an authentication function.

5. The print setting method according to claim 1, wherein
the setting information for the second setting item includes authentication information in an authentication function.

6. The print setting method according to claim 1, wherein
the setting file is an encrypted file.

7. An information processing apparatus comprising:
a storage that stores an application program that supports a print setting suited to a device in cooperation with a printer driver; and
a controller that performs the print setting based on setting information for a first setting item that is set by a user via a setting screen and setting information for a second setting item that is restricted from being set by the user via the setting screen, wherein
the controller
receives an operation to select a setting file containing the setting information for the second setting item, and
performs the print setting by reading the setting information for the second setting item from the setting file received.

8. The information processing apparatus according to claim 7, wherein
a file format of the setting file is a general-purpose format.

9. The information processing apparatus according to claim 8, wherein
a file format of the setting file is a text file format.

10. The information processing apparatus according to claim 7, wherein
the first setting item is a setting item related to an authentication function.

11. The information processing apparatus according to claim 7, wherein
the setting information for the second setting item includes authentication information in an authentication function.

12. The information processing apparatus according to claim 7, wherein
the setting file is an encrypted file.

13. A non-transitory tangible recording medium storing a program that causes a computer to implement the following functions that support a print setting suited to a device in cooperation with a printer driver;
performing the print setting based on setting information for a first setting item that is set by a user via a setting screen and setting information for a second setting item that is restricted from being set by the user via the setting screen,
receiving an operation to select a setting file containing the setting information for the second setting item, and
performing the print setting by reading the setting information for the second setting item from the setting file received.
